(19) United States
(12) Patent Application Publication
(10) Pub. No.: US 2019/0158493 A1
(43) Pub. Date: May 23, 2019

(54) TRIGGERING ROLE-BASED WORKFLOWS WITH USER AUTHENTICATION

(71) Applicant: Hewlett-Packard Development Company, L.P., Houston, TX (US)

(72) Inventors: Jason S. Aronoff, Fort Collins, CO (US); Steven J. Simske, Fort Collins, CO (US)

(73) Assignee: Hewlett-Packard Development Company, L.P., Houston, TX (US)

(21) Appl. No.: 16/098,091

(22) PCT Filed: Jul. 29, 2016
(86) PCT No.: PCT/US2016/044872

§ 371 Date: Oct. 31, 2018

(51) Int. Cl. H04L 29/06; G06F 9/48; G06K 19/10

(52) U.S. Cl. CPC H04L 63/0861; G06K 19/10; G06F 9/4806

(57) ABSTRACT

In one example in accordance with the present disclosure a method is described. According to the method, data associated with a variable data component is captured by a user computing device is received via a network. A user is authenticated by comparing biometric information for the user against a database of valid users. Responsive to an authentication of the user, role-based workflows are triggered. The role-based workflows are based on the biometric information for the user received from the user computing device and the data associated with the variable data component.

### BACKGROUND

Variable data component(s) (VDCs) are machine-readable components that contain embedded information. The embedded information, upon extraction, can perform any number of functions or trigger any number of workflows. For example, a scanning device of a mobile device can capture a printed variable data component. The embedded information can then be extracted, the information from which could direct a web browser of the mobile device to a particular website. Such variable data components can also be used in the detection of counterfeit products. The VDCs can also be used to drive the steps of other multi-step interactions.

### BRIEF DESCRIPTION OF THE DRAWINGS

The accompanying drawings illustrate various examples of the principles described herein and are a part of the specification. The illustrated examples are given merely for illustration, and do not limit the scope of the claims.

FIGS. 1A and 1B are diagrams of an environment for triggering role-based workflows with user authentication, according to an example of the principles described herein.

FIG. 2 is a flowchart illustrating a method for triggering role-based workflows with user authentication, according to an example of the principles described herein.

FIG. 3 is a diagram of a remote computing device for triggering role-based workflows with user authentication, according to an example of the principles described herein.

FIG. 4 is a flowchart illustrating a method for triggering role-based workflows with user authentication, according to an example of the principles described herein.

FIG. 5 is a diagram of a remote computing device for triggering role-based workflows with user authentication, according to another example of the principles described herein.

FIG. 6 is a diagram of a system for triggering role-based workflows with user authentication, according to an example of the principles described herein.

Throughout the drawings, identical reference numbers designate similar, but not necessarily identical, elements.

### DETAILED DESCRIPTION

Variable data component(s) (VDCs) can be used to encode information. The encoded information, once extracted, can be used to perform any number of functions. For example, encoded information in a VDC can be used to trigger subsequent workflows. As a specific example, a user may scan a QR code located at a bus stop with an image scanning tool (e.g. camera) of a mobile device, Information encoded in the OR code could direct the web browser of the mobile device to a web page that displays bus route information for busses passing that stop.

VDCs can also be used to assist in the detection of counterfeit products. For example, a printed VDC could be placed on a product package. A scanner of a mobile device can capture the VDC. The data is then parsed, either by the mobile device or a distributed service on a remote computing device, to retrieve the embedded information. In some examples, the embedded information includes an electronic security image that is returned to the mobile device. If the electronic security image matches a security image printed on the product package, a user may have some measure of confidence that the product is authentic. By comparison, if the printed security image does not match the transmitted security image, a user can acknowledge that the associated product may be counterfeit. While specific workflows are described herein, specifically as they relate to product authentication, the variable data components as described herein may be used to trigger any number of downstream workflows.

While such VDCs are useful in executing subsequent workflows and to some degree detecting counterfeit products, some characteristics of the environment in which the VDCs are used, reduce their more wide-spread implementation. For example, any workflow triggered by the scanning of a VDC is generic, and not user-specific. Returning to the above example, any user who scans a QR code at a bus stop will receive the same information, regardless of the identity of the user. Accordingly, fully customizable role-based workflows that are generated and executed based on user-specific information are not possible.

Still further, VDCs as used to authenticate products can be data-mined. For example, a data-mining bot, i.e., a computing application that runs automated scripts, can attempt to replicate a security image. In this example, an insidious third party can then print the replicated security image and fraudulently place that security image on a counterfeit product. More specifically, the bot could scan a barcode or permute numerical combinations represented by a barcode, and then poll the networked computing device for all variations of an associated security mark, which security mark could be a guilloche or other graphical alphanumeric (that is, set of symbols representing specific codes or strings). A counterfeiter could then place the guilloche on their own product, thus confusing a consumer as to the authenticity of a particular product.

Accordingly, to enhance the customization of workflows triggered by interacting with a VDC and to enhance security of these workflows, the present specification describes a user authentication operation that 1) improves the security of the downstream workflows and also 2) provides customizable workflows that are enabled via biometric information for the user, whose biometric information is gathered during an authentication operation. Such customizable workflows allow for tailored workflows based on user-specific information. Moreover, the downstream workflows may be device independent. In other words, a single computing device, such as a tablet on a manufacturing floor, could be used to provide role-specific workflows for different users, on account of the difference in biometric information provided during authentication of the user. As a specific example, different levels of authentication could be implemented for different users. For example, more rigorous degrees of authentication could be implemented for users who are likely to see sensitive information as compared to more relaxed degrees of authentication for users who are not going to see such sensitive information.

This customized workflow enablement is carried out after a user is authenticated. Such authentication requires user interaction such that the downstream workflows are only accessible after the user is authenticated. During such an authentication process, biometric information about the user is acquired. This information can be used to select or define, downstream workflows.

Specifically, the present specification describes a method. According to the method, a remote computing device acquires via a network, data associated with a variable data component, the variable data component of which is captured by a user computing device. A user of the user computing device is then authenticated by comparing biometric information for the user against a database of valid users. Responsive to an authentication of the user, a role-based workflow is triggered. The role-based workflow is based on the biometric information for the user and the data associated with the variable data component. The role-based workflow is also triggered independently of the user computing device used to acquire the data associated with the variable data component.

The present specification also describes a computing device. The computing device includes a receiving engine to receive via a network, data associated with a variable data component captured by a user computing device, A biometric authentication engine of the computing device authenticates the user relying on received biometric information for the user. Lastly, a workflow engine of the computing device, responsive to an authentication of the user, triggers a role-based workflow that is dependent upon the biometric information about the user received during authentication. The role-based workflow is not dependent, i.e., it is independent of the of the user computing device.

Still further, the present specification describes a computing system that includes a processor and a machine-readable storage medium coupled to the processor. An instruction set is stored in the machine-readable storage medium and is to be executed by the processor. The instruction set includes instructions to 1) receive via a network, data associated with a variable data component captured by a user computing device; 2) acquire biometric information relating to the user; 3) compare the biometric information against a database containing information for valid users to authenticate the user; and 4) trigger a role-based workflow responsive to an authentication of the user. As described above, allowing the role-based workflow to be initiated and/or continued is dependent upon the biometric information received for the user and the data associated with the variable data component but is independent of the user computing device.

Using such a method and system 1) provides customizable workflows for a particular user or group of users; 2) ties access to subsequent workflows to user identity; 3) enhances security via authentication using biometric information; 4) allows for definition of workflows before or in real-time based on biometric information acquired about the user; 5) facilitates adaptive workflows while using the same variable data components; 7) facilitates the identification of fraudulent users; and 8) dissuades data-mining by insidious third parties. However, it is contemplated that the devices disclosed herein may provide utility in addressing other matters and deficiencies in a number of technical areas. Therefore, the systems and methods disclosed herein should not be construed as addressing any of the particular matters.

As used in the present specification and in the appended claims, the term “workflow” refers to a defined series of computer-based tasks to produce a final outcome. Each step or stage in a series that makes up the workflow generally has one or more inputs and produces one or more outputs (including simply “states”) that transforms data. Accordingly, a role-based workflow refers to a workflow with a plurality of step-sequences whose number and order is specified beforehand and associated with a given role for a given user type, or agent.

Further, as used in the present specification and in the appended claims, the term “variable data component” refers to a component that can be interrogated (i.e., scanned, decoded, etc.) by a computing device and that stores encoded information. The variable data component may be printed, such as a barcode, or affixed to a surface such as an RFID chip. The variable data component may be physical as in the example of a printed or affixed variable data component, or it may be virtual, as in an image on a computer screen.

Still further, as used in the present specification and in the appended claims, the term “a number of” or similar language is meant to be understood broadly as any positive number including 1 to infinity; zero not being a number, but the absence of a number.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language indicates that a particular feature, structure, or characteristic described in connection with that example is included as described, but may not be included in other examples.

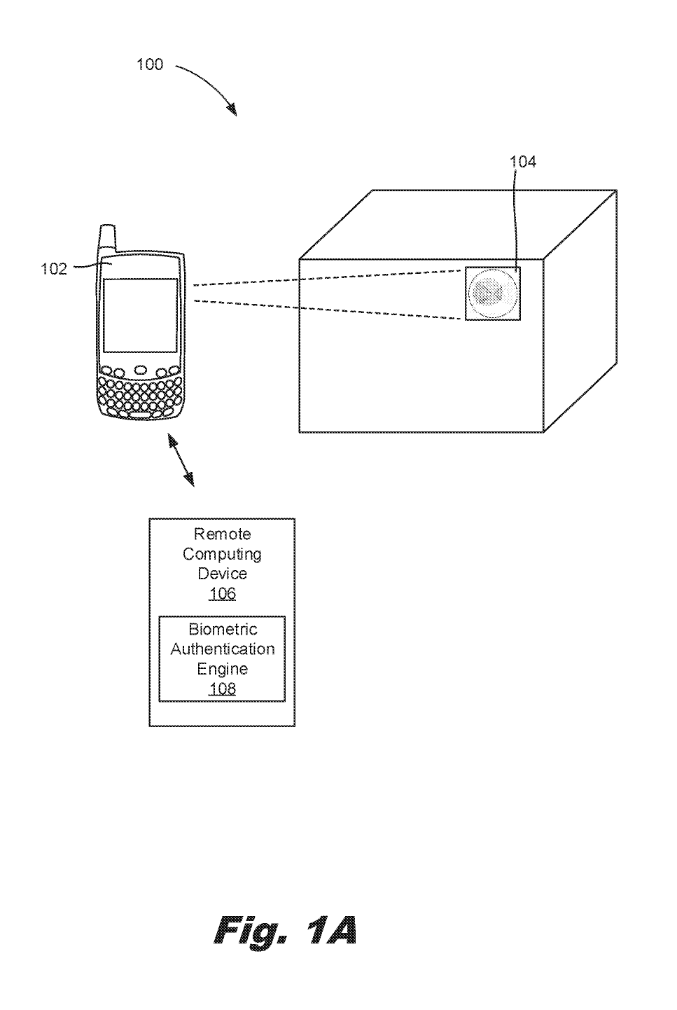

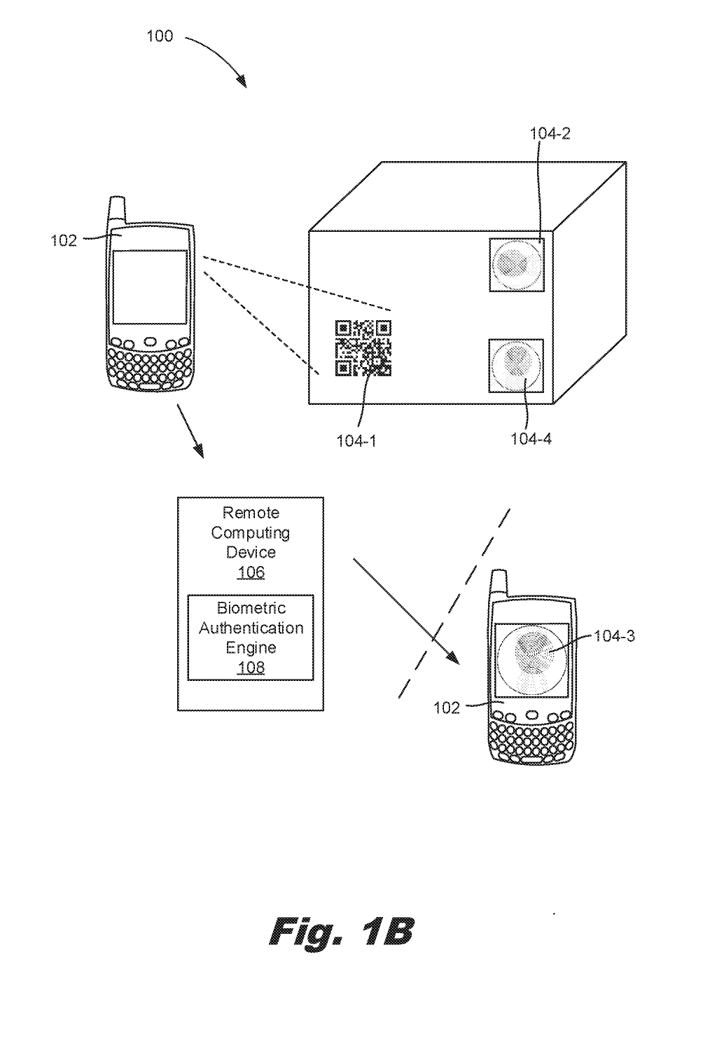

FIG. 1A is a diagram of an environment (100) for triggering role-based workflows with user authentication, according to an example of the principles described herein. As described above, variable data components, or VDCs (104) can be used to trigger workflows on the user computing device (102). Accordingly, a UDC (104) is any image, symbol, or other component that includes or references encoded information. Such variable data components (104) may be printable such as a guilloche or other graphical alphanumeric, 2D matrix, barcode, OR code or any visual mark that is suitable for printing. In some examples, the variable data component (104) is not printable but is a physical component that could be affixed to a surface. An RFID chip, or other memory device are other examples of such a physical VDC (104). Still further, while FIG. 1A depicts a variable data component (104) printed on a substrate, the variable data component (104) may also be an electronic component, such as an image displayed on an electronic screen.

Returning to the environment (100), in a first step a user employs a user computing device (102) having a capture device such as a scanner or a camera. Using this capture device, the user acquires data encoded by the variable data component (104). Specifically, as depicted in FIG. 1A, a camera or scanner can capture a digital image of a printed variable data component (104). In the case where the VDC (104) is an RFID chip, the user computing device (102) may include an RFID reader that can read variable bit streams. In yet another example, the VDC may be a small on-chip memory, and the capture device could be an embedded memory reader to read the small on-chip memory. While FIG. 1A depicts a mobile phone as the user computing device (102), any type of user computing device (102) may be implemented in accordance with the principles described herein. Other examples of user computing devices (102) include a personal computing device, a notebook, laptop computer, a tablet, a gaming system, or other user computing device (102) that has the capability of capturing a VDC (104) and processing data encoded therein.

The VDC (104) may include encoded information. For example, the VDC (104) may include information that at least in part identifies subsequent workflows that may be executed. This information, when used in conjunction with data gathered about the user computing device (102) during authentication, triggers role-specific workflows that may be a subset of workflows identified by data encoded in the VDC (104).

In a second step, the encoded information is passed to a remote computing device (106). The remote computing device (106) may be coupled to the user computing device (102) via any kind of connection including a wireless network or the Internet. The remote computing device (106) operates to authenticate the user of the user computing device (102) and not the user computing device (102) itself. Specifically, the VDC (104) may include information that triggers a biometric authentication engine (108) of the remote computing device (102). The biometric authentication engine (108) uses biometric information relating to the user to authenticate the user, and accordingly trigger subsequent user-specific workflows.

The biometric authentication engine (108) can either manually or automatically obtain the biometric information from the user computing device (102) and uses this biometric information to verify that the associated user is permitted to access subsequent workflows. This biometric information could also be used to select and/or define the workflow that is triggered.

When the user is authenticated, a subsequent workflow that is encoded in, or referenced by, the VDC (104) and that is defined, at least in part, by the biometric information is passed to, and executed by the user computing device (102). By comparison, if the user is not authenticated, then the user computing device (102) is prevented from executing subsequent role-specific workflows, and may be allowed to execute non-specific workflows, thus enhancing the security of workflows.

In this environment, using a distributed biometric authentication engine (108) to authenticate the user prior to a triggering of subsequent role-specific workflows, discourages data-mining. For example, the requirement to enter biometric information related to the user, i.e., adding a role-specific identification, allows for the discernment of counterfeiting. The increased ability to discern a counterfeit operation may dissuade data-mining, i.e., collecting the data associated with activating a workflow that the data-miner has no role-based right to act upon, as it would be less effective.

Moreover, by requiring the user to enter biometric information related to the user during authentication, subsequent workflows may be triggered that are unique to the user by being based on biometric information specific to the user.

FIG. 1B is another example of an environment (100), in which the system through which the workflows/data is transmitted is authenticated to a certain degree prior to biometric authentication. In one implementation, the system is defined to have less than 1 chance in 1 billion (1 in 10⁹) of a false positive identification. In this example, a preliminary VDC (104-1) is used to authenticate a system through which the workflows/data is transmitted, a pair of VDCs (104-3, 104-4) are used to gauge system confidence by allowing a user to compare a transmitted VDC (104-3) with a printed VDC (104-4) displayed on the computing device (102) and yet another VDC (104-2) is used to trigger subsequent workflows. This workflow-triggering VDC (104-2) is similar to the VDC (FIG. 1A, 104) described in FIG. 1A. Note that in FIG. 1B, similarly labeled elements between FIGS. 1A and 1B may refer to similarly operating components. Specifically, the user computing device (102), remote computing device (106), and biometric authentication engine (108) depicted in FIG. 1B may be similar to corresponding components described in FIG. 1A.

Specifically, a user may scan a preliminary VDC (104-1), such as a barcode, OR code, data matrix, guilloche, or other component that stores embedded information. Using information embedded in the preliminary VDC (104-1), the remote computing device (106) may identify and transmit an electronic version of another VDC (104-3), such as a guilloche. The VDCs identified by the numbers (104-3, 104-4) are used to gauge system confidence. Specifically, a user may compare the transmitted VDC (104-3) with a first printed VDC (104-4) by a side-by-side comparison of the transmitted VDC (104-3) and the printed VDC (104-4). If they match, a user can have confidence that the messages/transactions associated with the workflow and the remote computing device (106) are valid and not hacked and the user can continue on with further operations of the workflow. By comparison, if the transmitted VDC (104-3) does not match the printed VDC (104-4), then a user can be notified of impropriety or a hacking of the remote computing device (106) and can consequently opt out of subsequent tasks in the workflow.

The user can then be prompted to capture another, or role-based workflow triggering VDC (104-2), that similar to the VDC (FIG. 1A, 104) described in FIG. 1A, can contain the role-specific workflows as well as initiating the operation of the biometric authentication engine (108).

In FIG. 1B, the multiple user computing devices (102) indicate differences in time as distinguished by the dashed line. For example, in a first point in time, i.e., above the dashed line, the user computing device (102) is capturing the preliminary VDC (104-1) and in a second point in time, i.e., below the dashed line, the same user computing device (102) is receiving the transmitted VDC (104-3).

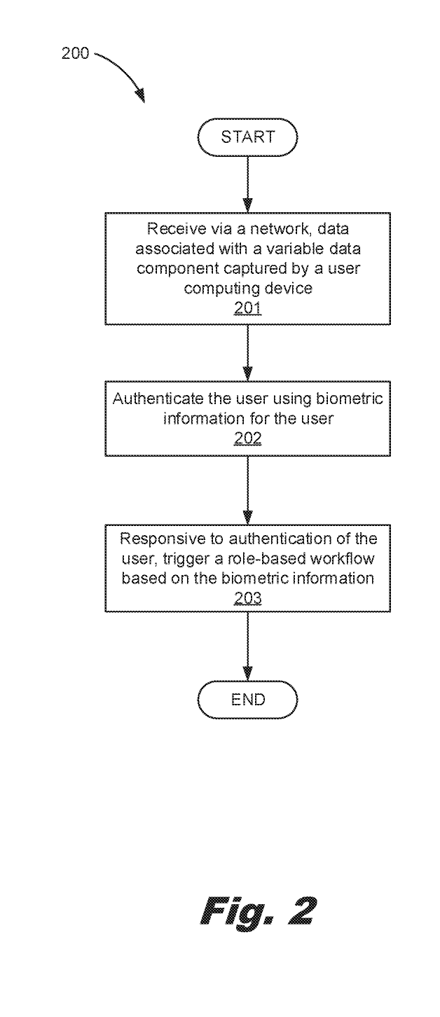

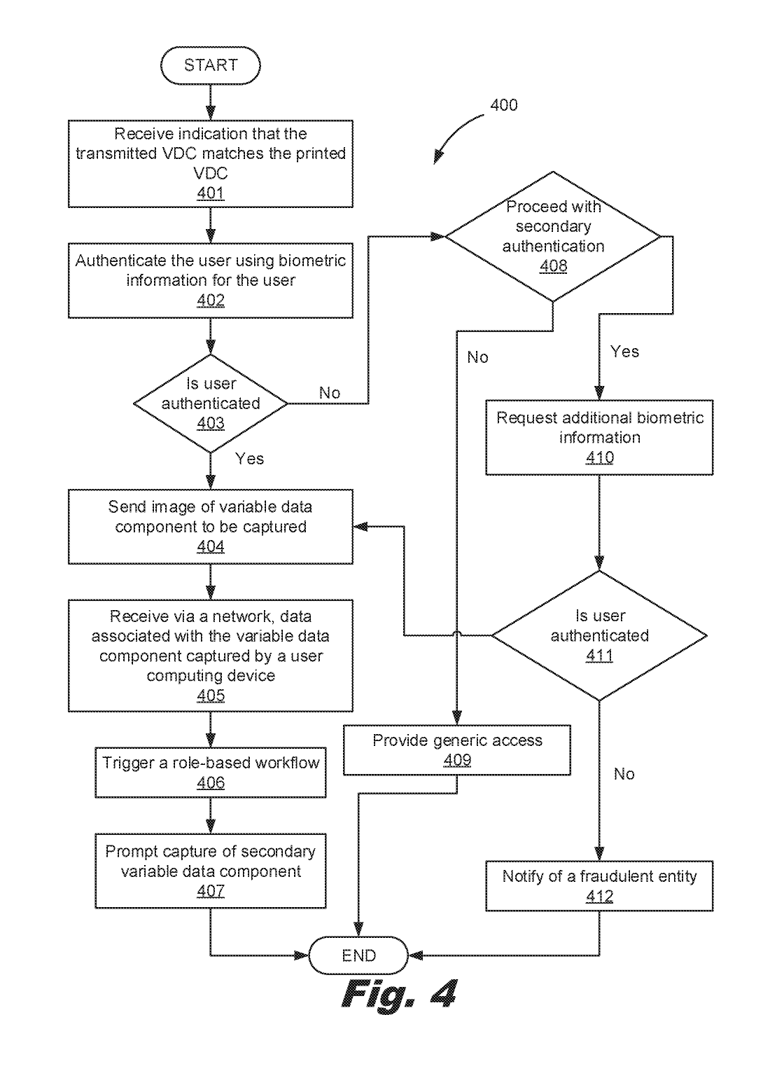

FIG. 2 is a flowchart illustrating a method (200) for triggering role-based workflows with user authentication, according to an example of the principles described herein. As a general note, the methods (200, 400) may be described below as being executed or performed by at least one device, for example, the remote computing device (FIGS. 1A and 1B, 106). Other suitable systems and/or computing devices may be used as well. The methods (200, 400) may be implemented in the form of executable instructions stored on at least one machine-readable storage medium of at least one of the devices and executed by at least one processor of at least one of the device. Alternatively, or in addition, the methods (200, 400) may be implemented in the form of electronic circuitry (e.g., hardware). While FIGS. 2 and 4 depict operations occurring in a particular order, a number of the operations of the methods (200, 400) may be executed concurrently or in a different order than shown in FIGS. 2 and 4. In some examples, the methods (200, 400) may include more or less operations than are shown in FIGS. 2 and 4. In some examples, a number of the operations of the methods (200, 400) may, at certain times, be ongoing and/or may repeat.

According to the method (200), data associated with a VDC (FIG. 1A, 104) acquired by a user computing device (FIG. 1A, 102) is received (block 201) via a network. The network may be any suitable network for communicating information including an intranet, the Internet or other computing network. In the case of a printed VDC (FIG. 1A, 104), a user computing device (FIG. 1A, 102) may include a camera, scanner, or other capturing device to capture a digital image of the printed VDC (FIG. 1A, 104). In the example of a non-printed VDC (FIG. 1A, 104), for example an RFID chip, the user computing device (FIG. 1A, 102) may include a reader component to acquire information stored in the RFID chip.

The data associated with the VDC (FIG. 1A, 104) may include various pieces of information. For example, as described above it may include data regarding subsequent workflows and instructions to initialize the biometric authentication engine (FIG. 1A, 108). For example, the data received (block 201) from the captured image can in part identify the different workflows. Then when information about the user is received during biometric authentication, the correct, or desired workflow from those identified by the data associated with the VDC (FIG. 1A, 104) can be selected.

Upon receipt of the data associated with the VDC (FIG. 1A, 104), the biometric authentication engine (FIG. 1A, 108) is initialized to authenticate (block 202) the user by comparing biometric information for the user against a database of valid users. In some cases, in authenticating the user, the remote computing device (FIG. 1A, 106) sends a request to the user computing device (FIG. 1A, 102) for the biometric information used to authenticate the user, Such a request may be either for manual user input or automatic acquisition of the biometric information. Accordingly, the remote computing device (FIG. 1A, 106) receives the biometric information and compares it against a database of valid users to determine if there is a match. As described above, different levels of authentication may be implemented based on any number of factors including the type of workflow, the number and/or type of users likely to attempt to execute the workflow, etc.

With specific regards to the biometric information, many user computing devices (FIG. 1A, 102) include biometric applications such as fingerprint scanners, facial recognition applications, and voice recognition applications that acquire biometric information for a user. Once sent to the remote computing device (FIG. 1A, 106) this biometric information can be parsed, analyzed and compared to a database that includes biometric information for valid users. If the biometric information provided by the user matches data found in the database, a user may be authenticated. By comparison, if the biometric information provided by the user does not match data found in the database, the user is not authenticated.

It should be noted that the threshold for authentication of the user may vary depending upon the particular application. For example, during authentication a statistical comparison may be performed between the received biometric information and the database of valid biometric information. If the nature of the workflow is highly sensitive, then a higher threshold, e.g. a higher statistical threshold or higher statistical confidence level, for similarity may be imposed as compared to a workflow that is not as sensitive. The threshold of the authentication may also be affected by any number of criteria including, the number of users that may have access to the user computing device (FIG. 1A, 102).

It should also be noted that the authentication of the user is independent of the user computing device (FIG. 1A, 102). In other words, a single user computing device (FIG. 1A, 102) could be used to authenticate multiple users. For this reason, the authentication is carried out by the remote computing device (FIG. 1A, 106) as opposed to being carried out on the user computing device (FIG. 1A, 102) itself. In this example, the user computing device (FIG. 1A, 102) mediates the biometric authentication by acquiring data about the workflows via the UDC (FIG. 1A, 104) and by providing the biometric information used by the biometric authentication engine (FIG. 1A, 108).

Upon successful authentication (block 202) of the user, the remote computing device (FIG. 1A, 106) can then trigger (block 203) a role-based workflow. For example, during authentication certain information about a user may have been acquired such as a person's demographic information, spatiotemporal information, position within an organization, personal preferences, etc. Using this information, a subsequent workflow is generated based on that person's role. In some examples, the role-specific workflow may be unique to the specific user. For example, based on personal information collected during authentication. In another example, the role-specific workflow may be unique to a group of which the user is a member. For example, the user may be a member of a management team that has greater access rights to information than does a member of a warehouse team. Specific examples of particular role-based workflows in accordance with the method (200) described herein are now provided.

In some examples, the role-based workflow is selected based on spatiotemporal information relating to the user. For example, during authentication it may be determined that the user is located in New York during the winter. Accordingly, the subsequent workflow could provide advertising for clothing companies in New York that offer winter attire. This example also illustrates that the workflows may be dynamic, meaning they may be defined after the generation of the VDC (FIG. 1A, 104). That is the workflow may be updated, but a mapping between the VDC (FIG. 1A, 104) and the workflow is still identified by the encoded data in the VDC (FIG. 1A, 104).

A few specific examples of downstream workflows that may be triggered are now provided. While specific examples are provided, any number of downstream workflows may be provided. In a multi-agent example, the identity of the agent changes during different stages of the workflow. For example, a first step may involve a signature from a buyer, and a second step may include accepting and archiving the document by a seller.

In another example, a manufacturer, distributor, warehouse retailer and consumer may each have a different mark to authenticate, which mark is based on at least one of their role, an authentication threshold and/or biometric threshold. In a multi-factor example, different VDCs could require different biometric flags to unlock. In a user-directed event example, a user can select from a list of options, and a different mark presented for triggering a selected option. In this example, selection of one option could disallow future use. In an object specific information delivery example, information on the interrogated object can be delivered via the user computing device (FIG. 1A, 102) or sent to a device/printer/email address, etc, of the users choice. In yet another example, information on the object interrogated could be shared amongst users. For example, such workflows could be used in gaming or cooperative couponing where the coupon savings increase as more friends participate.

According to the method (200) described herein, user interaction with the remote computing device (FIG. 1A, 106) via biometric authentication 1) enhances security of subsequent workflows, 2) provides for fully-customizable workflows, and in some cases 3) allows for more effective identification of counterfeiting operations as one or more of the VDCs are locked until biometric information is provided to unlock them via device authentication.

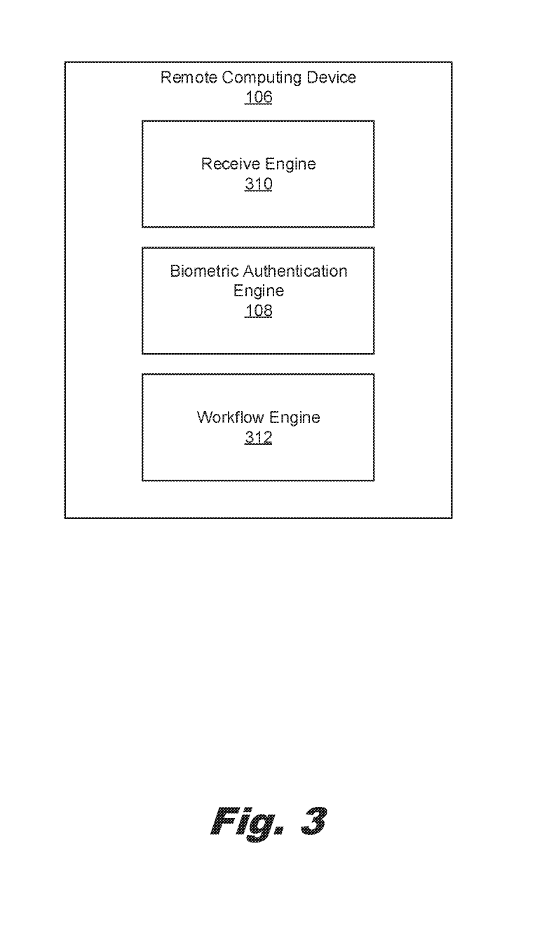

FIG. 3 is a diagram of a remote computing device (106) for triggering role-based workflows with user authentication, according to an example of the principles described herein. To achieve its desired functionality, the remote computing device (106) includes various hardware components, Specifically, the remote computing device (106) includes a number of engines. The engines refer to a combination of hardware and program instructions to perform a designated function. The engines may be hardware. For example, the engines may be implemented in the form of electronic circuitry (e.g., hardware). Each of the engines may include its own processor, but one processor may be used by all the modules. For example, each of the engines may include a processor and memory. Alternatively, one processor may execute the designated function of each of the modules.

As noted above, the remote computing device (FIG. 1A, 106) is remote from the user computing device (FIG. 1A, 102) that captures the VDC (FIG. 1A, 104). Doing so in part facilitates the authentication of multiple users via a single user computing device (FIG. 1A, 102).

A receive engine (310) receives via a network, data associated with a VDC (FIG. 1A, 104) captured by a user computing device (FIG. 1A, 102), For example, as described above, the user computing device (FIG. 1A, 102) via a scanner, camera or other capture device, captures a digital image of a printed VDC (FIG. 1A, 104). The user computing device (FIG. 1A, 102) can then send the image of the VDC (FIG. 1A, 104) to the receiving engine (310) of the remote computing device (106) to then be parsed, decoded, and interpreted. Accordingly, the receive engine (310) includes components to extract the embedded information from the image received from the user computing device (FIG. 1A, 102).

Upon receipt of the data associated with the VDC (FIG. 1A, 104), the biometric authentication engine (108) may then be initialized to authenticate the user using biometric information acquired relating to the user. As described above, the acquisition of such biometric information may include prompts for user input, or automatic retrieval from system memory. As described above, the biometric authentication engine (108) authenticates multiple users, sometimes using a single user computing device (FIG. 1A, 102). More specifically, as the biometric information is specific to a user, and not a user computing device (FIG. 1A, 102), biometric information for a specific user is distinguishable from biometric information for other users, and therefore can be distinguished during authentication. As a specific example, the remote computing device (106) could be a tablet at a point of sale, which can be used by various customers. As each customer has different biometric information, each individual user is independently authenticated, and is provided corresponding role-specific workflows, regardless of the specific user computing device used to capture the VDC (FIG. 1A, 104).

The remote computing device (106) also includes a workflow engine (312) to trigger a role-based workflow based on information about the user received during biometric authentication and based on the data encoded in the VDC (FIG. 1A, 104). As described above, such a workflow is independent of the user computing device (FIG. 1A, 102) that acquired the data from the VDC (FIG. 1A, 104). For example, as described above, the initial VDC (FIG. 1A, 104) may include information identifying a number of different workflows. Then, during authentication, personal information about a user is acquired. A database includes a mapping between possible workflows and those permitted for the user based on the personal information gathered during authentication.

As a specific example, a delivery agent may be able to execute a workflow where they see the tracking information for a package with sensitive information. The information identifying the delivery agent and his/her permissions as far as subsequent workflows are concerned may be received during biometric authentication of the delivery agent. By comparison, a manager of the organization may be able to execute a workflow where they see additional information such as an author or source of the sensitive information. Similarly, the information identifying the manager and his permissions as a far as subsequent workflows are concerned may be received during biometric authentication of the manager.

Accordingly, the remote computing device (106) of the present specification provides fully customizable workflows based on personal information gathered. The workflows may be uniquely tailored to an individual or based on the individual's role within an organization, or within a more general environment. These workflows can be easily updated on the remote computing device (106) without changing the corresponding VDC (FIG. 1A, 104).

FIG. 4 is a flowchart illustrating a method (400) for triggering role-based workflows with user authentication, according to an example of the principles described herein. According to the method (400), prior to performing biometric authentication, an operation to determine the statistical confidence of the system is performed. Specifically, a user may scan a preliminary VDC (FIG. 1B, 104-1) which may be a barcode, OR code, data matrix, guilloche or other component that stores embedded information. Using this information received from the user computing device (FIG. 1B, 102), the remote computing device (FIG. 1B, 106) may identify and transmit an electronic version of a VDC (FIG. 1B, 104-3) used to determine system confidence. A user may then compare the transmitted VDC (FIG. 1B, 104-3) for determining system confidence with a printed VDC (FIG. 1B, 104-4) for determining system confidence imposed/composed on a substrate.

Specifically, the user can engage in a side-by-side comparison of the transmitted VDC (FIG. 1B, 104-3) for determining system confidence and the printed VDC (FIG. 1B, 104-4) for determining system confidence. If they match, a user can have confidence that the messages/transactions associated with the workflow and the remote computing device (FIG. 1B, 106) are valid and not hacked and that the user can continue on with further operations of the workflow. By comparison, if the transmitted VDC (FIG. 1B, 104-3) for determining system confidence does not match the printed VDC (FIG. 1B, 104-4) for determining system confidence, then a user can be notified of impropriety or a hacking of the remote computing device (FIG. 1B, 106) and can consequently opt out of subsequent tasks in the workflow. Accordingly, a user interface may be presented that facilitates indication that the transmitted VDC (FIG. 1B, 104-3) for determining system confidence and the printed VDC (FIG. 1B, 104-4) for determining system confidence match. Accordingly, the remote computing device (FIG. 1B, 106) receives (block 401) an indication that the transmitted VDC (FIG. 1B, 104-3) for determining system confidence matches the printed VDC (FIG. 1B, 104-4) for determining system confidence. Performing such a system-confidence operation prior to user authentication ensures a user that the device/service that is to receive their subsequent authentication information, which may include personal information, is reputable and valid, as compared to one that has been hacked, or otherwise compromised.

Next, the user may be authenticated (block 402) as described above in connection with FIG. 2. If the user is successfully authenticated, (block 403, determination YES), the remote computing device (FIG. 1B, 106) sends (block 404) an indication, such as an image or audio mention of the VDC (FIG. 1B, 104-2) to be captured, which VDC (FIG. 1B, 104-2) can trigger the subsequent role-specific workflows. A user can then capture the indicated VDC (FIG. 1B, 104-2), and accordingly, the remote computing device (FIG. 1B, 106) receives (block 405) data associated with the indicated VDC (FIG. 1B, 104-2). This can be performed as described above in connection with FIG. 2.

A role-based workflow may then be triggered (block 406) as described above in connection with FIG. 2. Instigating a role-based workflow after authentication provides increased security throughout the workflow and also allows for customized workflows based on the mapping between the user biometric information gathered during authentication and the available workflows.

In some examples, the role-based workflows may be triggered (block 406) by prompting (block 407) the capture of a secondary VDC (FIG. 1B, 104-2). For example, following authentication, the remote computing device (FIG. 1B, 106) may send the user computing device (FIG. 1B, 102), a workflow-triggering VDC. The user, upon scanning a corresponding second printed VDC, may initiate a workflow that has been selected for the user based on the entity information.

If the user is not authenticated (block 403, determination NO), it may be determined whether to proceed (block 408) with secondary authentication. For example, a user, although providing accurate biometric information, may not be authorized to proceed. If secondary authentication is not carried out, (block 408, determination NO), generic access, or role-generic workflows, are provided (block 409). If, however, a user elects to proceed (block 408, determination YES) with secondary authentication, additional biometric information could be requested (block 410). For example, as described above different levels of authenticity may be required based on the application, users, number of users, etc. of the environment. Accordingly, initial biometric information may be insufficient to satisfy a particular authentication threshold. In this example, the additional biometric information could be requested (block 410). The additional biometric information could also accommodate for glitches or inconclusive initial biometric information. For example, a user may have a dirty finger, which could cloud the acquisition of biometric information from a fingerprint reader. If the additional biometric information results in the user being authenticated (block 411, determination YES), an image of the variable data component to be captured is sent (block 404).

However, when such additional information does not result in authentication (block 411, determination NO), a notification (block 412) of fraudulence may be sent. Such a notification could be sent to the user, or some other organization such as a law enforcement agent, or other regulatory agency. Such a notification in some examples could also block usage of the user computing device (FIGS. 1A and 1B, 102).

As such, the method (400) as described herein facilitates fully customizable workflows based on specific user information, which increases the ability to effectively deliver information, execute tasks, or otherwise interact with users.

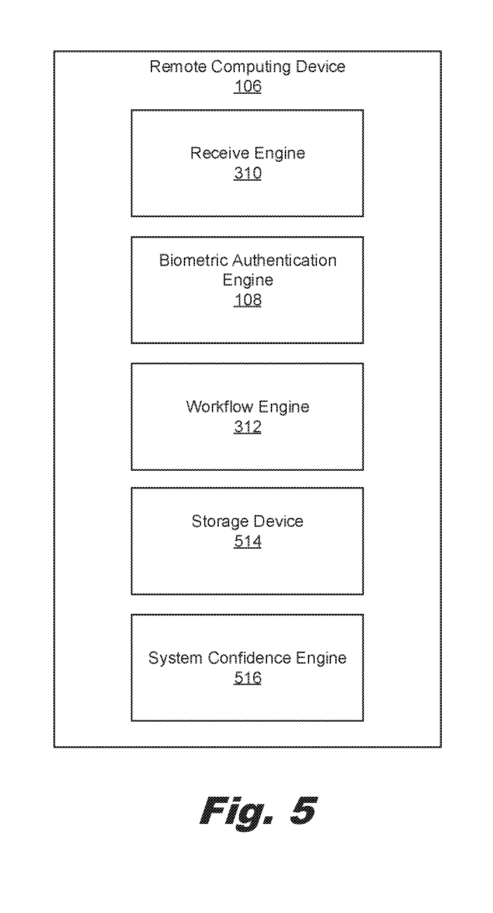

FIG. 5 is a diagram of a remote computing device (106) for triggering role-based workflows with user authentication, according to another example of the principles described herein. The remote computing device (106) includes some components previously described including the receive engine (310), the biometric authentication engine (108), and the workflow engine (312).

The remote computing device (106) also includes a storage device (514) to store information about valid users. It is against this database stored in the storage device (514) that biometric information about the user is compared to authenticate the user. For example, the storage device (514) may include biometric information for valid users. The information in the storage device (514) may identify those users that are permitted to continue with the workflow.

The storage device (514) also includes a mapping between valid users and subsequent workflows. For example, if biometric information received from the user computing device (FIGS. 1A and 1B, 102) indicates the user as a particular type of user, i.e., a manager, then a specific workflow may be triggered. In other words, the workflow is dependent upon the identity of the user.

The remote computing device (106) also includes a system confidence engine (516). The system confidence engine (516) is responsible for transmitting, generating and receiving the system confidence mark described earlier. In other words, via the system confidence engine (516) a user may have additional reassurance that biometric information and subsequent workflow(s) is secure.

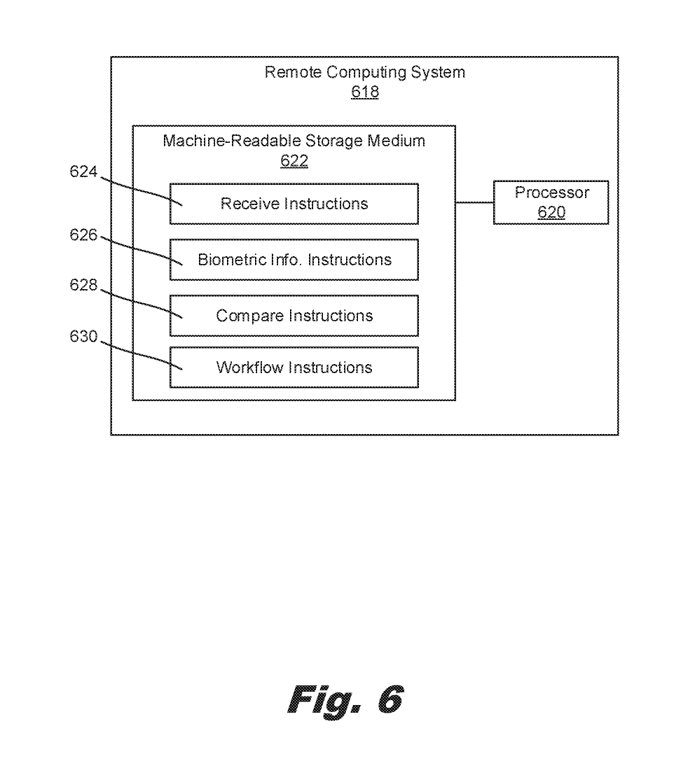

FIG. 6 is a diagram of a remote computing system (618) for triggering role-based workflows with user authentication, according to an example of the principles described herein. In some examples, the remote computing system (618) may be a component of the remote computing device (FIGS. 1A and 1B, 106) described earlier.

The remote computing system (618) includes a processor (620) and machine-readable storage medium (622) coupled to the processor (620). Although the following descriptions refer to a single processor (620) and a single machine-readable storage medium (622), the descriptions may also apply to a remote computing system (618) with multiple processors and multiple machine-readable storage mediums. In such examples, the instructions may be distributed (e.g., stored) across multiple machine-readable storage mediums and the instructions may be distributed (e.g., executed by) across multiple processors.

The processor (620) may include other resources used to process programmed instructions. For example, the processor (620) may be a number of central processing units (CPUs), microprocessors, and/or other hardware devices suitable for retrieval and execution of instructions stored in machine-readable storage medium (622). In the remote computing system (618) depicted in FIG. 6, the processor (620) may fetch, decode, and execute instructions (624, 626, 628, 630) to enable a role-based workflow following user authentication. As an alternative or in addition to retrieving and executing instructions, the processor (620) may include a number of electronic circuits comprising a number of electronic components for performing the functionality of a number of the instructions in the machine-readable storage medium (622). With respect to the executable instruction representations (e.g., boxes) described and shown herein, it should be understood that part or all of the executable instructions and/or electronic circuits included within one box may, in alternate examples, be included in a different box shown in the figures or in a different box not shown.

The machine-readable storage medium (622) represent generally any memory capable of storing data such as programmed instructions or data structures used by the remote computing system (618). The machine-readable storage medium (622) includes a machine-readable storage medium that contains machine readable program code to cause tasks to be executed by the processor (620). The machine-readable storage medium (622) may be tangible and/or non-transitory storage medium. The machine-readable storage medium (622) may be any appropriate storage medium that is not a transmission storage medium. For example, the machine-readable storage medium (622) may be any electronic, magnetic, optical, or other physical storage device that stores executable instructions. Thus, machine-readable storage medium (622) may be, for example, Random Access Memory (RAM), an Electrically-Erasable Programmable Read-Only Memory (EEPROM), a storage drive, an optical disc, and the like. The machine-readable storage medium (622) may be disposed within the remote computing device (106), as shown in FIG. 6. In this situation, the executable instructions may be “installed” on the remote computing device (106). Alternatively, the machine-readable storage medium (622) may be a portable, external or remote storage medium, for example, that allows the remote computing device (106) to download the instructions from the portable/external/remote storage medium. In this situation, the executable instructions may be part of an “installation package”. As described herein, the machine-readable storage medium (622) may be encoded with executable instructions for dual-power reception.

Referring to FIG. 6, receive instructions (624), when executed by a processor (620), may cause the remote computing system (618) to receive via a network, data associated with a variable data component (FIG. 1A, 104) captured by a user computing device (FIGS. 1A and 1B, 102). Biometric information instructions (626), when executed by a processor (620), may cause the remote computing system (618) to acquire biometric information relating to the user. Compare instructions (628), when executed by a processor (620), may cause the remote computing system (630) to compare the biometric information against a database containing information for valid users to authenticate the user. Workflow instructions (630), when executed by a processor (620), may cause the remote computing system (618) to trigger a role-based workflow responsive to an authentication of the user. The role-based workflow is dependent upon the biometric information received for the user and the data associated with the variable data component (FIG. 1A, 104), but is independent of the user computing device (FIG. 1A, 102). Accordingly, the instructions implement a multi-stage authentication system. The first stage instructions provide a system-confidence authentication and the second stage instructions include the compare instructions (628).

In some examples, the processor (620) and machine-readable storage medium (622) are located within the same physical component; such as a server, or a network component. The machine-readable storage medium (622) may be part of the physical component's main memory, caches, registers, non-volatile memory; or elsewhere in the physical component's memory hierarchy. Alternatively, the machine-readable storage medium (622) may be in communication with the processor (620) over a network. Thus, the remote computing device (106) may be implemented on a user computing device, on a server; on a collection of servers, or combinations thereof.

The remote computing system (618) of FIG. 6 may be part of a general purpose computer. However, in alternative examples, the remote computing system (618) is part of an application specific integrated circuit.

Using such a method and system 1) provides customizable workflows for a particular user or group of users; 2) ties access to subsequent workflows to user identity; 3) enhances security via authentication using biometric information; 4) allows for definition of workflows before or in real-time based on biometric information acquired about the user; 5) facilitates adaptive workflows while using the same variable data components; 7) facilitates the identification of fraudulent users; and 8) dissuades data-mining by insidious third parties. However; it is contemplated that the devices disclosed herein may provide utility in addressing other matters and deficiencies in a number of technical areas. Therefore, the systems and methods disclosed herein should not be construed as addressing any of the particular matters.

Aspects of the present system and method are described herein with reference to flowchart illustrations and/or block diagrams of methods, apparatus (systems) and computer program products according to examples of the principles described herein. Each block of the flowchart illustrations and block diagrams, and combinations of blocks in the flowchart illustrations and block diagrams, may be implemented by computer usable program code. The computer usable program code may be provided to a processor of a general purpose computer, special purpose computer, or other programmable data processing apparatus to produce a machine, such that the computer usable program code, when executed via, for example, the processor (620) of the remote computing system (618) or other programmable data processing apparatus, implement the functions or acts specified in the flowchart and/or block diagram block or blocks. In one example, the computer usable program code may be embodied within a computer readable storage medium; the computer readable storage medium being part of the computer program product. In one example, the computer readable storage medium is a non-transitory computer readable medium.

The preceding description has been presented to illustrate and describe examples of the principles described. This description is not intended to be exhaustive or to limit these principles to any precise form disclosed. Many modifications and variations are possible in light of the above teaching.

What is claimed is:

1. A method comprising:
receiving via a network, data associated with a variable data component captured by a user computing device;
authenticating the user by comparing biometric information for the user against a database of valid users;
responsive to an authentication of the user, triggering a role-based workflow based on the biometric information for the user received from the user computing device and the data associated with the variable data component.

2. The method of claim 1, further comprising, requesting additional biometric information for the user, when initial authentication results lack sufficient confidence in the user identity.

3. The method of claim 2, further comprising performing an operation selected from the group consisting of:
providing a mechanism for the remote computing system to report fraudulence when one or more elements selected from the group consisting of the additional biometric information and the variable data components for determining system confidence results in a lack of sufficient confidence by the remote computing system; and
providing a mechanism for the user to report a lack of confidence in the system and terminate a session when the user is unsatisfied with one or more representations of variable data components.

4. The method of claim 1, wherein the role-based workflow is selected based on spatiotemporal information relating to the user.

5. The method of claim 1, further comprising sending an image of the variable data component to be captured responsive to an indication that a transmitted variable data component for determining system confidence matches a printed variable data component for determining system confidence.

6. The method of claim 1, wherein the role-based workflow comprises prompting a user to capture a second variable data component that triggers a workflow specific to the user.

7. The method of claim 1, further comprising generating the role-based workflow in real-time based on the biometric information.

8. The method of claim 1, wherein the role-based workflow is unique to at least one of the elements selected from the group comprising a group of users or a specific user.

9. A computing device comprising:
a receiving engine to receive via a network, data associated with a variable data component captured by a user computing device;
a biometric authentication engine to authenticate the user relying on received biometric information for the user; and
a workflow engine to, responsive to an authentication of the user, trigger a role-based workflow dependent upon information about the user received during authentication and independent of the user computing device.

10. The computing device of claim 9, further comprising a storage device to store information about valid users against which biometric information about the user is compared during authentication of the user.

11. The computing device of claim 9, wherein the system is remote from a user computing device that captures the variable data component.

12. The computing device of claim 9, wherein the biometric authentication engine authenticates multiple users of a single user computing device based on different biometric information received for the multiple users.

13. The computing device of claim 9, wherein the system further comprises a system confidence engine to ensure validity of the biometric authentication engine.

14. A computing system comprising:
a processor;
a machine-readable storage medium coupled to the processor; and
an instruction set stored in the machine-readable storage medium to be executed by the processor, wherein the instruction set comprises;
instructions to receive via a network, data associated with a variable data component captured by a user computing device;
instructions to, acquire biometric information relating to the user;
instructions to, compare the biometric information against a database containing information for valid users to authenticate the user; and
instructions to, responsive to an authentication of the user, trigger a role-based workflow dependent upon the biometric information received for the user and the data associated with the variable data component and independent of the user computing device.

15. The computing system of claim 14, wherein the instruction set further comprises instructions to implement, a multi-stage authentication system, wherein a first stage instructions provide a system-confidence authentication, and the second stage instructions comprises the instructions to compare the biometric information against the database containing information for valid users.
